(19) United States
(12) Patent Application Publication
(10) Pub. No.: US 2020/0111451 A1
(43) Pub. Date: Apr. 9, 2020

(54) VIRTUAL REALITY EFFECTS ACCESSORY

(71) Applicants: Mitchell C. Angeloni, Apollo Beach, FL (US); Jose Betancourt, Tampa, FL (US)

(72) Inventors: Sidney E. Francies, III, Lithia, FL (US); Mitchell C. Angeloni, Apollo Beach, FL (US); Jose Betancourt, Tampa, FL (US)

(21) Appl. No.: 16/673,177

(22) Filed: Nov. 4, 2019

Related U.S. Application Data
(62) Division of application No. 16/152,760, filed on Oct. 5, 2018.

(51) Int. Cl. G09G 5/12; A63F 13/25

(52) U.S. Cl. CPC G09G 5/12; A63F 2300/8082; A63F 13/25

(57) ABSTRACT

A virtual reality effects accessory can include a virtual reality headset, an accessory attachment for a virtual reality headset, or a tabletop accessory for providing a fully immersive virtual user experience for a user using a virtual reality entertainment system. The virtual reality headset can include effects emitted from an outlet on the headset such as mist or wind. The accessory attachment for the virtual reality headset can provide for adding additional effects to the virtual reality experience, such as mist. The tabletop accessory can be utilized in addition to an entertainment system to provide for additional effects for the virtual reality experience. All provide for a more immersive virtual reality experience.

CROSS-REFERENCE TO RELATED APPLICATION(S)

This application claims the benefit of and is a divisional of U.S. patent application Ser. No. 16/152,760, filed Oct. 5, 2018, which is incorporated herein by reference in its entirety.

### BACKGROUND

Virtual reality has become a focal point in entertainment; particularly in the gaming industry. Typically, a user's virtual reality experience is provided with a headset that is worn by the user. The headset either includes a screen, or is capable of screen attachment to the headset, such as with a smart phone attaching to the headset. A set of lenses in the headset, as well as a set of motion sensors provide for simulating a virtual, visual experience, where the user is visually simulated within a virtual environment. Additionally, a set of headphones connected to the headset can provide for virtual sound associated with the virtual environment. However, with the focus on virtual reality entertainment, there is a desire to provide for a fully immersive virtual reality experience beyond sight and sound.

### BRIEF SUMMARY

In one aspect, the disclosure relates to a virtual reality headset for simulating a virtual environment for a user, the virtual reality headset comprising: a body adapted to mount to the user's head; a viewing area provided on the body configured to be positioned at the user's eyes and including a pair of lenses; a screen mounted within the body in visual relationship with the lenses for providing a visual virtual environment to the user via the lenses; at least one outlet provided on the body positioned to direct at least one effect toward the user's head; wherein the at least one effect is at least one of wind or mist emitted from the at least one outlet.

In another aspect, the disclosure relates to an accessory for a virtual reality headset for simulating a virtual environment, the accessory comprising: a set of connectors for mounting the accessory on the virtual reality headset; at least one outlet provided on the virtual reality headset positioned to direct an effect toward the user's head; wherein the effect is mist emitted from the at least one outlet.

A tabletop accessory for providing virtual reality effects to a user, the tabletop accessory comprising: a body including a set of walls defining an interior; a set of effects accessories mounted within the body configured to emit a set of virtual effects to the user; wherein the tabletop accessory is configured to emit the set of virtual effects to the user positioned in front of the tabletop accessory from the set of effects accessories.

### BRIEF DESCRIPTION OF THE DRAWINGS

In the drawings:

FIG. 1 is a perspective view of a virtual reality headset with outlets for emitting virtual effects.

FIG. 2 is a perspective view of the virtual reality headset of FIG. 1 illustrating an internal system for dispensing air and mist via the outlets.

FIG. 3 is a perspective view of an accessory for a virtual reality headset including outlets for emitting virtual effects.

FIG. 4 is a top schematic view of an accessory for a virtual reality headset.

FIG. 5 is a perspective view of the virtual headset accessory of FIG. 4 with internal effects systems illustrated in dashed line.

FIG. 6 is a top view of another accessory for a virtual reality headset.

FIG. 7 is a front view of the accessory of FIG. 6, illustrating outlets for emitting virtual effects.

FIG. 8 is a perspective view of a virtual reality tabletop accessory with multiple virtual effects outlets for emitting multiple virtual effects.

FIG. 9 is a schematic, section view of the virtual reality tabletop accessory of FIG. 8.

FIG. 10 is a schematic, cross-sectional view of the virtual reality tabletop accessory of FIG. 8, illustrating a liquid reservoir with a pump.

FIG. 11 is a perspective view of an alternative organization for the virtual reality tabletop accessory of FIG. 8.

FIG. 12 is a perspective view of another alternative organization for the virtual reality tabletop accessory of FIG. 8.

### DETAILED DESCRIPTION

Aspects of the present disclosure relate to a virtual reality headset, an add-on or accessory for a virtual reality headset, and a virtual reality tabletop accessory. More specifically, the headset or accessories can provide a user with additional virtual effects to provide a more immersive virtual reality experience beyond merely, visual, audio, and vibrational effects, which currently limit the virtual reality experience. For example, the headset or accessories can provide for on-demand wind, heat, cold, sound, mist, smell, taste, or particulate matter as may be represented in the virtual environment that the user is experiencing.

For purposes of description related to the figures, the terms “upper,” “lower,” “right,” “left,” “rear,” “front,” “vertical,” “horizontal,” and derivatives thereof shall relate to the invention as oriented in the attached figures, and should not be construed as limiting, but rather to assist the reader in understanding the material. However, it is to be understood that aspects of the present disclosure may assume various alternative orientations, except where expressly specified to the contrary. Furthermore, as used herein, a ‘set’ of elements can include any number of elements, including only one of said elements.

An entertainment system, such as a video system, a gaming system, a video game system, or connectable mobile device like a smart phone, as used herein, should be understood as a set of hardware or operating software that is connected to the virtual reality headset or accessories for running, controlling, or otherwise inputting information to the virtual reality headset or accessory related to a virtual reality environment, which can be interpreted by the virtual reality headset or accessory in order to generate and emit related virtual effects as they relate to the virtual reality environment. In one non-limiting example, a video game system can be connected to the virtual reality headset or accessory to provide instruction to the virtual reality headset or accessory to operate effects in concert with the virtual reality environment generated by the video game system.

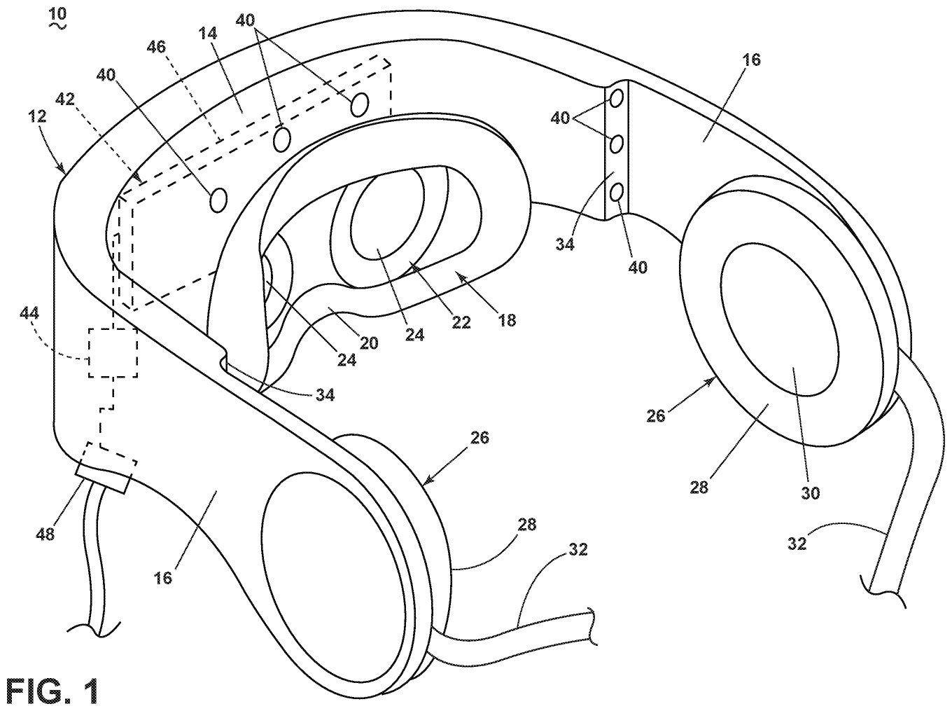

Referring now to FIG. 1, a perspective view of a virtual reality headset 10 includes a body 12 having a face portion 14 and a pair of opposing ear portions 16 extending from the face portion 14. The body 12 can be made of a strong, yet light-weight material, such as plastic or composites. Such a material is preferably strong enough to protect the interior components of the virtual reality headset 10 during a drop or fall, while being light-weight to wear upon a user's head without creating discomfort.

The face portion 14 can include a cushion 18 configured to rest on a user's face. The cushion 18 can include a ridge 20 adapted to rest on a user's nose, while the remainder of the cushion 18 surrounds the user's eyes. A viewing area 22 can be provided within the cushion 18, adapted to position in front of the user's eyes. A pair of lenses 24 can be provided in the viewing area 22 to enlarge and simulate a visual virtual environment to the user.

The ear portions 16 can each include an integrated headphone 26, with each headphone 26 including an ear cushion 28 and a speaker 30. The headphones 26 of the ear portions 16 can be adapted to secure at a user's ears to provide audio to the user associated with the visual virtual reality environment via the speakers 30. An optional strap 32 can couple to one or more of the ear portions 16, adapted to secure about a user's head to further secure the virtual reality headset 10 to the user's head. The strap 32 can be adjustable to fit any size user. Additionally, it is contemplated that that strap can be coupled to any part of the body 12, such that a suitable strap system to support the virtual reality headset on the user's head is achieved, preferably in a comfortable manner. Alternatively, the ear portions 16 could compressively secure the virtual reality headset 10 to the user's head.

A set of effect outlets 40 can be provided in various locations on the body 12. As shown, the outlets can be provided at the face portion 14 located above the cushion 18, and can be provided in vertical arrangement at side portions 34 along the ear portions 16. The outlets 40 can be arranged in the face portion 14 and the side portions 34 to be directed toward the head or face of a user wearing the virtual reality headset 10. It should be understood that the number, organization, and position of the outlets 40 is exemplary, and that any number arrangement, or placement of outlets 40 is contemplated among the body 12. Preferably, the outlets 40 are arranged in a manner that is directed towards the user's head, face, or skin, such that the user readily senses the particular effect emitted from the outlet 40.

The body 12 can be partially or wholly hollow, defining an interior 42. A controller 44 can be provided in the interior 42, with the controller 44 adapted to control the function of the virtual reality headset 10. For example, the controller 44 can include a printed circuit board (PCB) including a central processing unit (CPU) and a memory, or any other component required for operation of the virtual reality headset 10. The controller 44 can further include a motion sensor, such as a gyroscope, in order to interpret movement of the user, such as looking up, down, or side to side. Additionally, a screen 46 can be provided in the interior 42, where the screen 46 can display a visual virtual reality environment, which is magnified with the lenses 24 to the user. The screen 46 can be operably coupled to the controller 44 to control operation of the screen 46 as it relates to the user's movement, operation, or experience with the virtual environment. While the screen 46 is shown as integrated into the virtual reality headset 10, it is contemplated that the screen 46 can be removably connected to the virtual reality headset 10, such as connecting a mobile phone or smart phone to the virtual reality headset 10, and operably connecting the mobile phone to the controller 44 to associate operation of the mobile phone as the screen 46 with functionality of the virtual reality headset 10. While the outlets 40 appear over the screen 46, it should be appreciated that the outlets would be positioned about the periphery of the body 12, and not on the screen 46. Similarly, the outlets 40 can be positioned in a manner providing sufficient space for the screen 46 when connected as a mobile phone.

An input 48 can also be provided in the body 12. The input 48, for example, can be a Universal Serial Bus input, such as Universal Serial Bus (USB) 2.0 or USB 3.0, or any other suitable input such as a High-Definition Multimedia Interface (HDMI) or Category-5 (Cat-5) input or other female connector in non-limiting examples. While only a single input 48 is shown, it is contemplated that multiple inputs 48 can be included, such as an input for communicatively coupling to an entertainment system and a second input 48 for providing electrical power to the virtual reality headset 10, or connecting separate, optional headphones at a headphone input. The input 48 can provide information to the controller 44, such as software information related to the virtual reality experience, such as connecting to a gaming system or entertainment system. In one example, the input 48 can connect to a video gaming system, such that the user can play the video game in the virtual reality environment via the virtual reality headset 10. In this way, the software information is sent to the controller 44, which is parsed by the controller 44, and provided to the user via screen 46, the speakers 30, and the outlets 40 coordinated with or in concert with the video game played on the video game system. While the input 48 is shown as a plug-in input 48, it should be further understood that the input could be wireless, and integrated into the controller 44. For example, the input can be a wireless module, such as a Wi-Fi or Bluetooth module, permitting communication between the virtual reality headset 10 and an external entertainment system, such as the video game system. Similarly, the input 48 can be a power charging input, where the headset is battery powered, and the input 48 provides for charging the virtual reality headset 10. In this way, it is contemplated that the virtual reality headset 10 can be operated wholly wirelessly.

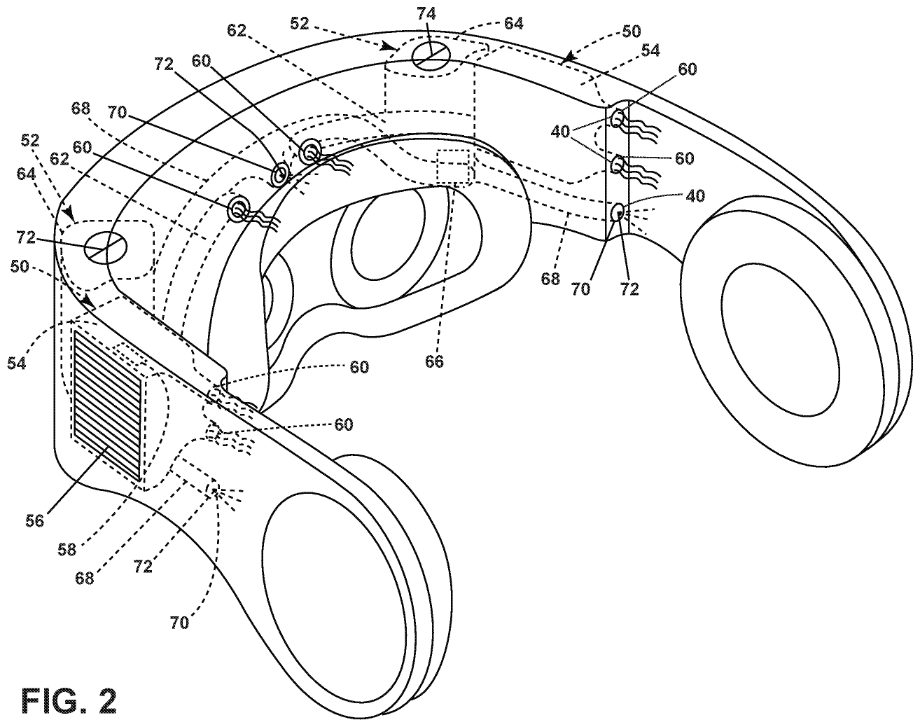

Referring now to FIG. 2, the virtual reality headset 10 includes additional components provided in the interior 42 for providing additional virtual effects beyond visual and audio effects alone. In the exemplary virtual reality headset 10, an interior air system 50 and an interior mist system 52 are provided, each of which can be operably and communicably coupled to the controller 44 of FIG. 1.

The air system 50 can include an air chamber 54, including a vent 56 opening the air chamber 54 and an internal fan 58 (shown schematically for clarity) configured to drive air through the air chamber 54 from the vent 56. At least some of the outlets 40 can be air outlets 60 provided on the body 12 at the air chamber 54, while some of the air outlets 60 can be provided at other locations on the body 12, coupled to the air chamber 54 via one or more air conduits 62. In this way, the controller 44 can operate the air system 50 by operating the fan 58 to provide a flow of air from the vents 56, to the air chamber 54, and through the air outlets 60 to a user. In this way, a flow of air in the virtual environment can be provided to the user to virtually simulate the flow of air. For example, a breeze can be simulated with the air provided from the air outlets 60. Furthermore, it is contemplated that the air system 50 can further be used to simulate temperature. For example, the air system 50 could include a heating unit (not shown) provided in the air chamber 54, such as a heating coil, or a cooling unit (not shown) provided in the air chamber 54, which could provide local heating or cooling to the user, which could further simulate the virtual temperature of the virtual environment. For example, in a sunny or tropical environment, the heat could be provided to the user so the user may feel the heat or a warm breeze of the virtual environment. Similarly, for example, in an arctic environment, the use of cold air provided from the air system 50 could enable the user to feel the cold or a cold breeze of the virtual environment.

The interior mist system 52 includes a liquid reservoir 64 with a pump 66, which can be filled with a liquid at a resealable inlet 74. The pump 66 can be operably coupled to the controller 44 of FIG. 1 to control operation of the mist system 52 for pumping a volume of fluid from the reservoirs 64. One or more mist conduits 68 can be coupled with one or more outlets 40 as mist outlets 70. The mist outlets 70 can include a mist nozzle 72 configured to mix liquid pumped from the liquid reservoir 64 with air to form a mist or atomized liquid spray to be sprayed from the mist outlets 70. In this way, a mist can be provided to the user to simulate liquid or water in the virtual environment. For example, where a user is near a waterfall in the virtual environment, the mist could simulate the mist falling from the waterfall. Additionally, the mist can be used on demand by the user to cool the user if the virtual reality headset 10 becomes warm during use. In one example, the mist feature could be selectively controlled by the user for on-demand cooling, such as with a button on the virtual reality headset 10 or an integrated feature into the virtual reality environment or software. Additionally, it is contemplated that the mist system 52 can be used in conjunction with the air system 50, utilizing the air system 50 to form the mist with the liquid from the mist system 52. Furthermore, it is contemplated that the mist system 52 can be utilized for olfactory effects or smell. For example, a mist outlet 70 can be placed adjacent the ridge 20 adjacent to a user's nose during use. The mist system 52 could be used to atomize and provide a scented mist to the user's nose to simulate the virtual environment. For example, a rose smell could be emitted while the user is in a field of roses in the virtual environment. More particularly, a particular virtual environment can be provided with a predetermined scent array, which can be operably coupled to the pump 66, such that a plurality of associated scents can be utilized. In this way, the mist system 52 can be capable of providing a liquid, mist, or atomized liquid spray to the user to simulate a virtual effect of the virtual environment.

The nozzles or outlets as described herein may include atomizers for introducing atomized liquid into the air or toward the user. Atomized liquid generally refers to droplets, a mist, or a fine spray. Droplet size is often dictated by pressure, specific gravity, viscosity and other physical features in combination with the flow rate of the air and the liquid itself. Airflow influences the homogeneous distribution of the atomized liquid in the air. By way of example, an atomizer may break up liquid into droplets having an average size of approximately 160 microns at a 20psi water flow rate, though the scope of the present disclosure is not limited to these particular droplet sizes and pressure.

While FIG. 2 is limited to an air system 50 and a mist system 52, it is contemplated that additional or different systems can be utilized, including by not limited to a heat system, a cooling system, an air or wind system, a mist or water system, a smell or olfactory system, or a particulate matter system, such as sand. Particulate matter as used herein, can include solid matter material which is emitted toward a user to simulate a virtual environment including such particulate matter, such as sand, dust, or ash in non-limiting example, but not a liquid or mist material, which would be emitted by the mist or water system. Such systems can be integrated into the virtual reality headset 10 and operably connected to the controller 44 to associate additional virtual effect with the virtual environment beyond visual and audio effects. In one example, the particulate matter material could be dispensed into the air system, and emitted to the user via the air outlets 60.

A software developer or video retailer, such as a movie developer or designer, video game designer, or a video virtual reality designer, or anyone else who may create or adapt a virtual environment, can incorporate environmental effects programming into the virtual environment. For example, in a windy virtual environment of the game, the software can include programmed cues to operate the air system 50 to simulate the wind of the virtual environment. In another example, in a wet or rainy environment, the software can include programmed cues to operate the mist system 52 to simulate the wet or rainy virtual environment. In this way, the developer can program additional environmental effects into the video game virtual environment, which can be provided to the user, which can provide for an improved immersive virtual reality experience. It is further contemplated that the virtual reality headset 10 can include its own software operable by the controller 44 to operate the virtual reality headset based upon an interpretation of the virtual environment. For example, while a virtual reality gaming system provides only a visual and audible output, the virtual reality headset 10 could include software configured to interpret the virtual reality environment and operate the additional virtual effects, such as wind or mist, based upon an interpretation of the virtual environment.

The virtual reality headset 10 provides for a more fully immersive virtual reality experience, which incorporates more of a user's senses than only visual and audio or haptic virtual experiences. Therefore, the virtual reality headset 10 provides for an improved virtual reality experience.

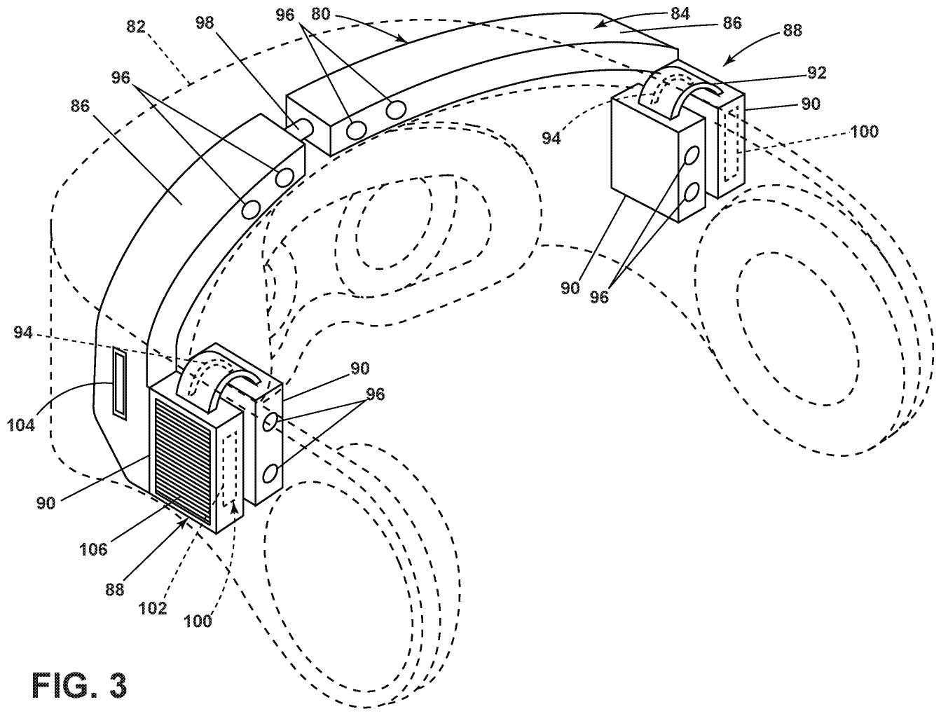

Referring now to FIG. 3, an effects accessory or accessory 80 for a virtual reality headset 82 is shown. The virtual reality headset 82 can be an existing virtual reality headset 82, such as a headset for a dedicated virtual reality system, such as a gaming system. The effects accessory 80 can be removably attachable and communicatively connectable to the virtual reality headset 82.

The accessory 80 can include a body 84 including a cross-band 86 coupled to a pair of opposing connectors 88. The connectors 88 can be two-part, including opposing connector portions 90 connected by a junction 92. The junction 92 can be flexible, such that the connector portions 90 can be positioned on either side of a portion of the virtual reality headset 82 and the effects accessory 80 is supported at the junction 92. In one example, the junction 92 can include a spring hinge such that the opposing connector portions 90 squeezably couple to the virtual reality headset 82. Additionally, the junction 92 can provide for interior conduits 94 providing for communication between the opposing connector portions 90. For example, a flow of air can be provided over the interior conduits 94 or an electrical conduit for electrical communication can be provided in the interior conduits 94. A set of outlets 96 can be provided in each of the opposing connectors 88, shown as having two outlets in one connecting portion 90 of each set of opposing connectors 88.

The cross-band 86 can couple between the opposing connectors 88, coupling to one connector portion 90 of each of the sets of opposing connectors 88. In this way, the cross-band 86 can be positioned to rest in front of a user's forehead, while it is contemplated that the cross-band 86 be shaped or positioned in other ways, such as resting on the top of a user's head. The cross-band 86 can include an adjustment 98 for adjusting the length of the cross-band 86. In this way, the effects accessory 80 can adjust to different user head sizes or different virtual reality headsets 82. Outlets 96 can also be provided in the cross-band 86.

An effects mechanism 100 can be provided in one of the opposing connectors 88 or in the cross-band 86. For example, the effects mechanism 100 can be a fan 102, which can be used to draw a volume of air through a vent 106, which can be exhausted through one or more of the outlets 96 via the interior conduits 94. In this way, the effects accessory 80 can be used to simulate wind for a virtual environment, blowing on a portion of the user's head or face. Alternatively, the effects mechanism 100, for example, could be a pump and actuator system, coupled to a liquid reservoir within a portion of the body 84 or connected to the body 84, adapted to provide a volume of liquid from one or more of the outlets 96 as a mist, which can be used to simulate a moist or misty virtual environment, such as near a waterfall or ocean, for example. It should be appreciated that any effect can be integrated into the effects accessory 80, such as a heat system, a cooling system, an air or wind system, a mist or water system, a smell or olfactory system, or a particulate matter system, such as sand in non-limiting examples.

Furthermore, it is contemplated that the effects accessory 80 can include more than one different effects mechanism 100, such as a liquid pump, as well as a fan, providing the effects accessory with the capability of both wind and mist, to further simulate the virtual environment for the user. Additional effects can include, but are not limited to wind, air, heat, cold, water, mist, particulate matter, or smell. Such an effect accessory 80 provides for a more immersive virtual reality experience, appealing to more of a user's senses than that of just visual, audio, and haptic sensory feedback. Additionally, the effects accessory 80 can provide for a modular addition to an existing virtual reality headset or system, without requiring the user to purchase a complete new headset or system, which can reduce cost.

Additionally, the effects accessory 80 can be communicatively or operably coupled to the virtual reality headset 82, or an entertainment system, such that the wind or air in the virtual environment is provided to the effects accessory 80 to operate in order to simulate the wind or air of the virtual environment. In one example, the effects accessory 80 can include an input 104, such as a USB input or HDMI input, which can be used to communicatively connect with the virtual reality headset 82 or an entertainment system. In another example, the effects accessory 80 can be battery powered, and the input 104 can be used to charge the effects accessory 80. Alternatively, the effects accessory 80 can have wireless capability, such as WiFi or Bluetooth, which can be used to wirelessly connect and communicate with the virtual reality headset 82 or an entertainment system.

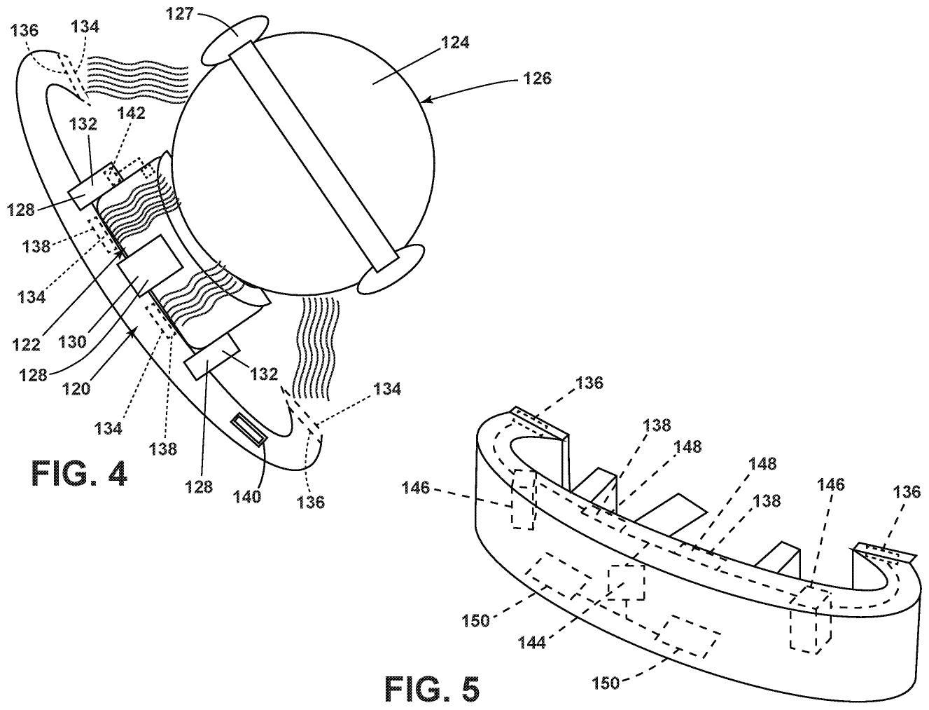

Referring now to FIG. 4, another exemplary effects accessory or accessory 120 is shown coupled to a virtual reality headset 122. The virtual reality headset 122 is mounted upon or worn on the head 124 of a user 126. Additionally, a set of headphones 127 are shown worn on the user's head 124. The effects accessory 120 can include a set of mounts 128 including a top mount 130 and a set of side mounts 132. The mounts 128 couple the effects accessory 120 to the virtual reality headset 122 in order to maintain the position of the effects accessory 120 during movement of the user 126 during a virtual reality experience. The effects accessory 120 can also include a set of outlets 134, shown as four exemplary outlets 134. The outlets 134 can be arranged as two side outlets 136 and two central outlets 138, while any suitable number or arrangement of outlets 134 is contemplated.

The effects accessory 120 can include a first input 140. The input 140 can be adapted to couple to a power source to provide power to the effects accessory 120, or can couple to an entertainment system to provide information to the effects accessory 120. Additionally, the effects accessory 120 can include a second input 142 configured to couple to the virtual reality headset 122. In this way, the second input 142 can electrically and communicatively couple to the virtual reality headset 122 to provide power and or instructions for operation of the effects accessory 120 in concert with the virtual reality headset 122. Alternatively, it is contemplated that the effects accessory 120 can be wireless, having a wireless communication module configured to wirelessly communicate with the virtual reality headset 122 or an entertainment system, or can have a plurality of different inputs to connect to multiple sources, being electrical, communicative, or otherwise.

Referring now to FIG. 5, the effects accessory 120 is shown with interior components shown in broken line. A controller 144 is provided in the accessory 120 and can communicatively couple with an entertainment system or the virtual reality headset 122 to provide operation of the effects accessory 120 in concert with the virtual reality headset 122. For example, the side outlets 136 can be mist outlets, coupled with a set of fluid reservoirs 146, which can be pump actuated to provide a mist effect to the user upon instruction from the entertainment system or the virtual reality headset 122. The two central outlets 138 can be air outlets, and can include fans 148 at the outlets 138 to provide a wind effect to the user. Two additional bottom outlets 150 can be provided at the bottom of the effects accessory 120, which can provide additional effects to the user, such as additional wind, mist, heat, cold, smell, or particulate matter; the distribution of which can be controlled by the controller 144 as it relates to the virtual reality experience from the entertainment system or the virtual reality headset 122.

In this way, the effects accessory 120 can be quickly and easily connected to an existing virtual reality headset, communicatively coupled to the virtual reality experience, and can provide the user with a more immersive virtual reality experience. Such additional effects can include wind, mist, water, heat, cold, smell, or particulate matter. Such additional effects relate to additional user sensations or a virtually immersive experience beyond simply sight and sound or haptic feedback.

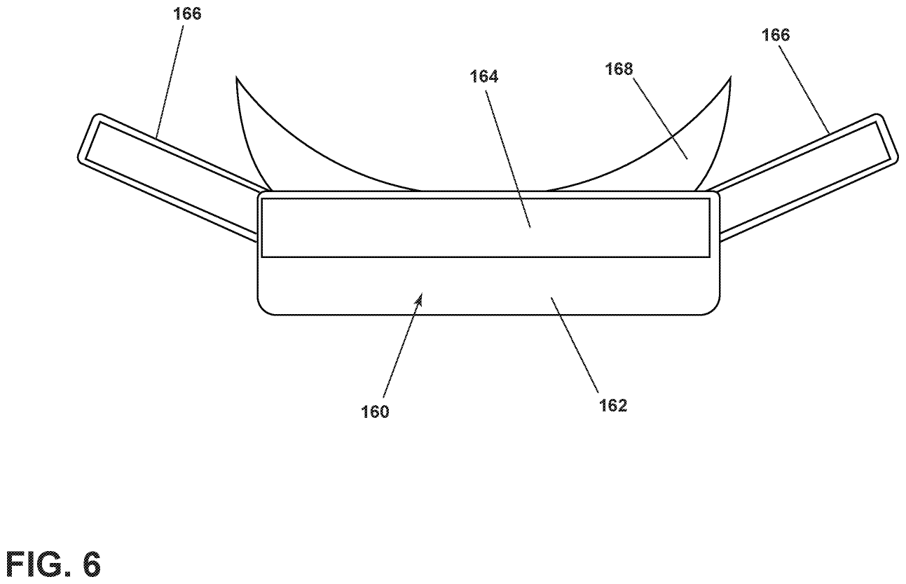

Referring now to FIG. 6, a top view of another effects accessory 160 is shown including a body 162 having an upper portion 164 and two side portions 166. The body 162 can be adapted to be received over the front of a virtual reality headset 168, such as any preexisting virtual reality headset 168. Additionally, it is contemplated that the body 162 is made of an adjustable or flexible material, such as polymer, permitting quick and secure attachment of the body 162 to the virtual reality headset 168.

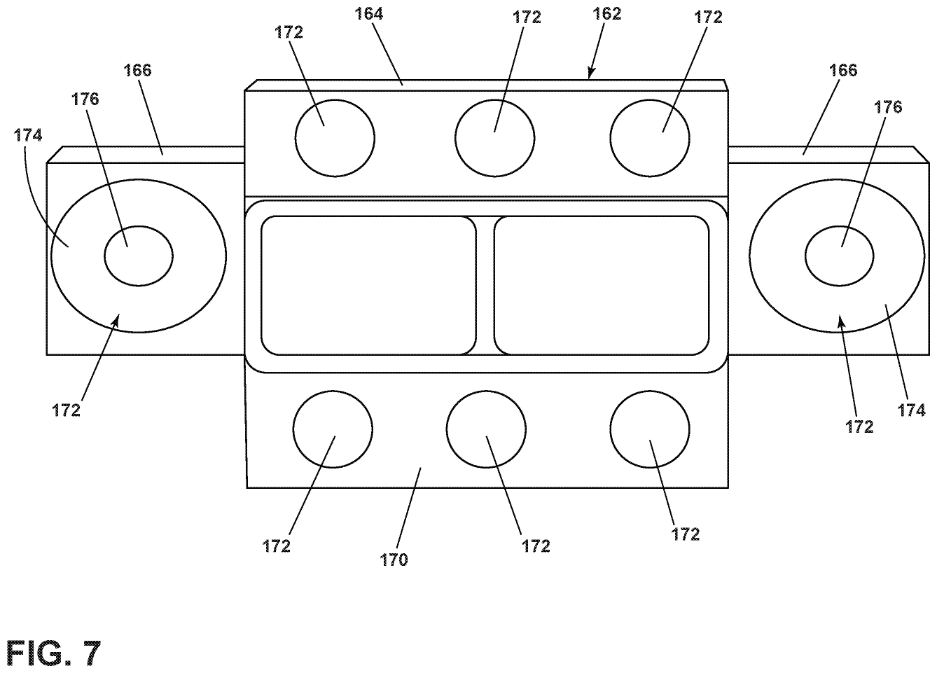

Referring now to FIG. 7, the body further includes a lower portion 170, which can be similar to the upper portion 164, positioned opposite of the upper portion 164 relative to the body 162. Each of the upper portion 164, the side portions 166, and the lower portion 170 can include a set of outlets 172, shown as three outlets 172 on each of the upper and lower portions 164, 170, and one outlet 172 provided on each of the side portions 166. The outlets 172 can provide for dispensing, generating, or otherwise providing an effect to the user, such as wind, mist, heat, cool, or smell, in non-limiting examples. In another example, the outlets 172 can be two-part, including a fan portion 174 and a mist portion 176, where the fan portion 174 can include a fan configured to blow a volume of air toward a user, and the mist portion 176 can have a mister or atomizer, coupled to a liquid supply for providing a mist effect to a user. The fan portion 174 can provide for blowing the mist from the mist portion 176 toward the user.

Additionally, the effects accessory 160 can include interior components, such as a controller (not shown) configured to control operation of the effect accessory 160, as well as incorporate the effects produced by the effects accessory 160 with the rest of the virtual reality experience, such as that of the visual and audio effects provided by the virtual reality headset 168. Such interior components can be similar to those as discussed in FIGS. 2-5.

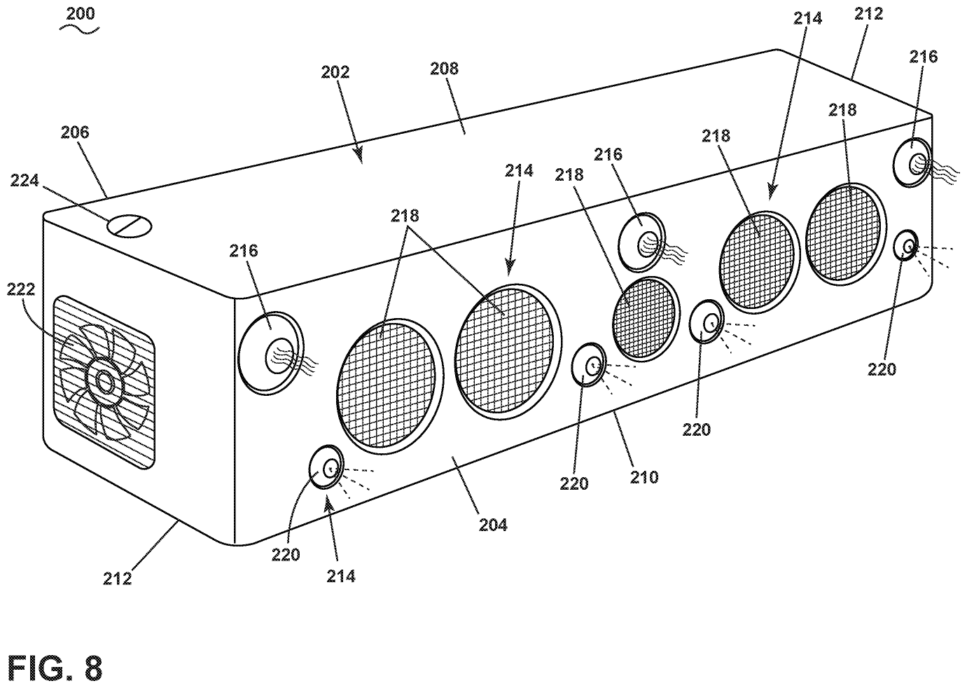

Referring now to FIG. 8, a virtual reality tabletop accessory 200 includes a body 202 having a substantially rectangular, cubic, or prism shape, with a front wall 204, a rear wall 206, a top wall 208, a bottom wall 210, and opposing sidewalls 212. A set of effects accessories 214 can be provided on the front wall 204, while it is contemplated that the effects accessories 214 can be positioned anywhere on the body 202 suitable to provide an effect to a user.

The effects accessories 214 can include a set of blowers 216, a set of speakers 218, and a set of mist nozzles 220. Non-limiting examples of additional effects accessories 214 can include a heater, a cooler, a scent distributor such as a diffuser, or a particulate matter dispenser, or organized combinations of any effect accessory. The blowers 216 can include a set of vented outlets, which can include adjustable louvers, for example, to direct a flow of air toward a user. An inlet fan 222 can be positioned on the sidewall 212 adjacent the blower 216 and can provide a volume of air to the blower 216.

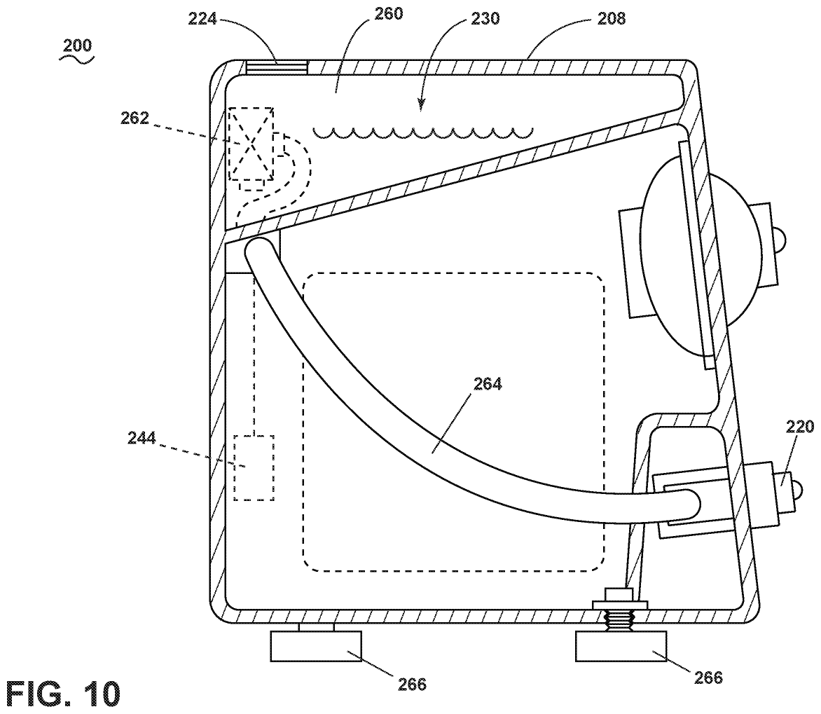

Similarly, the set of mist nozzles 220 can be provided in the front wall 204 and can include an outlet with a nozzle or other similar elements configured to direct an atomized spray or mist toward a user. A pump and liquid supply or reservoir, as well as an atomizer, can be connected to the mist nozzles 220, and will be described in further detail in the discussion of FIG. 10. A fill cap 224 can be provided in the top wall 208 providing access to a liquid reservoir for supplying the mist nozzles 220.

The set of speakers 218 can also be provided in the front wall 204 directed toward a user oriented in front of the virtual reality tabletop accessory 200.

It should be appreciated that the particular type and arrangement of the effects accessories 214 as shown in FIG. 8 is exemplary, while any suitable arrangement or use of effects accessories 214 is contemplated. In one example, the tabletop accessory 200 can be modular or customizable, permitting rearrangement, replacement, removal, or addition of different effect accessories 214, as may be tailored to the particular virtual reality experience of the user. More specifically, where a virtual reality environment is in a wet area, the mist nozzles 220 may be desirable, whereas in a hot dry environment, heaters may be desirable. In this way, the effects accessories 214 can be tailored to the particular virtual reality experience to provide a more immersive virtual reality experience. A modular assembly could provide a greater ability to tailor the particular virtual reality experience to the particular virtual environment.

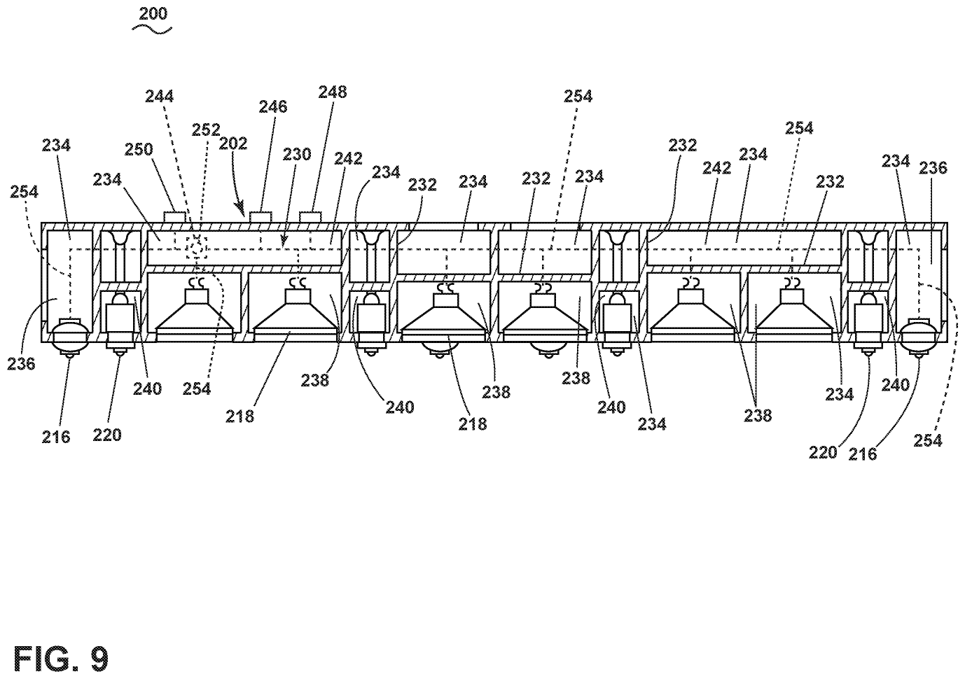

Referring now to FIG. 9, showing a schematic top view of the virtual reality tabletop accessory 200, the body 202 can further define an interior 230 for the tabletop accessory 200. A set of internal walls 232 can separate the interior 230 into individual chambers 234. More specifically, the individual chambers 234 can be categorized based upon the particular component or effects accessory 214 provided in said chamber 234. For example, a fan chamber 236 can include the fan 222 and the blower 216, a speaker chamber 238 can include the speaker 218, and a mist chamber 240 can include the mist nozzle 220. While it is shown that each chamber 234 includes one effects accessory 214, it should be understood that there can be more or less chambers 234, or any number of chambers 234, including only one as defined by the body 202, and any number of effects accessories 214 can be provided in any one chamber 234. However, it can be desirable to physically separate some effects accessories 214, such as liquid and electrical accessories, such as the speaker 218 and the mist nozzle 220, for example, to avoid any potential liquid passing to the electrical accessories.

A rear chamber 242 can be positioned adjacent the rear wall 206, such as behind the speakers 218, and can include a controller 244 and one or more inputs 246. The controller 244 can include a microprocessor and memory, for example, and can be electrically and operably coupled to the effects accessories 214. The inputs 246 can include a power input 248 and a data input 250. The power input 248 can provide power to the controller 244 and to the effects accessories 214 or other operational components within the tabletop accessory 200, while the data input 250 can provide for wired communication with external components, such as a virtual reality system or entertainment system. Optionally, the controller 244 can include a wireless communication module 252, configured to wirelessly communicate with the external components or external entertainment system.

A series of electrical connectors 254, such as wires, can couple the effects accessories 214 to the controller 244 to operate and power the effects accessories 214. In this way, the controller 244 can control operation of the tabletop accessory 200 via the operation of the effects accessories 214.

Referring now to FIG. 10, a schematic side view illustrates the interior 230 of the tabletop accessory 200. An interior liquid reservoir 260 is provided beneath the top wall 208 and is fillable at the fill cap 224. A pump 262 is provided within the liquid reservoir 260, and can be operably coupled to the controller 244, and can selectively provide a volume of liquid to the mist nozzle 220 for selectively dispensing a liquid mist toward a user. A fluid conduit 264 can fluidly couple the pump 262 and the liquid reservoir 260 to the mist nozzle 220. The liquid reservoir 260 can span the length of the tabletop accessory 200, and can include multiple pumps 262 dedicated to multiple mist nozzles 220. Alternatively, it is contemplated that the liquid reservoir 260 is arranged along the bottom wall 210. In this way, leakage from the liquid reservoir 260 would not leak onto any electrical components, which would minimize damage during a leak event.

Additionally, a pair of feet 266 can be coupled to the body 202 at the bottom wall 210. The feet 266 can be adjustable to arrange the angle of the effects accessories 214 or to level the tabletop accessory 200.

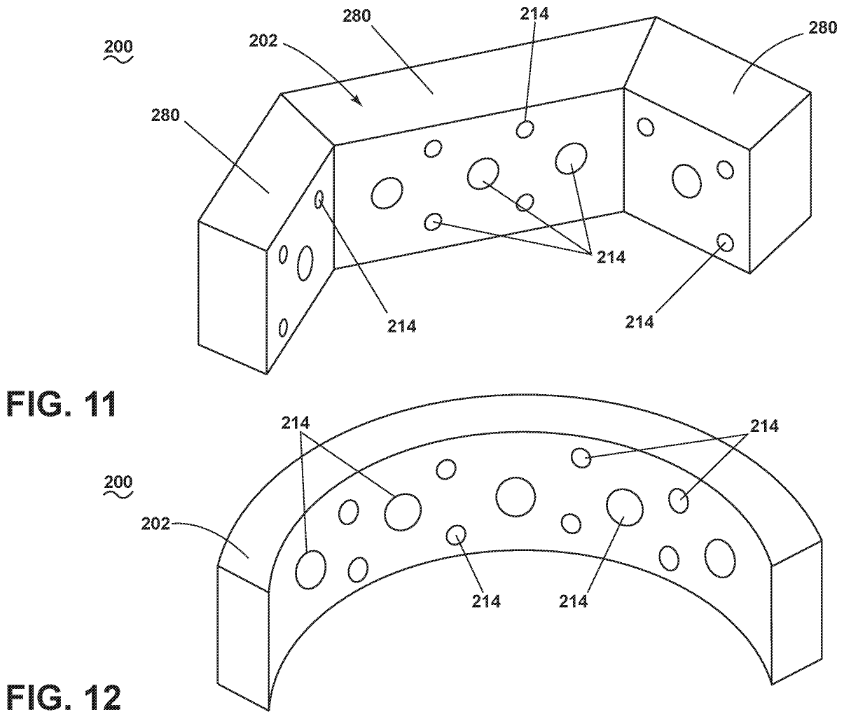

Referring now to FIGS. 11 and 12, the tabletop accessory 200 can have different shapes or geometries configured to at least partially surround the user. FIG. 11 includes a sectioned shape for the body 202, having three sections 280, with outer sections 280 angled relative to the center section 280 to partially surround a user. FIG. 12 includes a rounded, curved shape for the body 202, which is configured to partially surround the user. In this way, the shapes of FIGS. 11 and 12, or other similar shapes, can at least partially surround the user, which can provide for providing the immersive virtual reality experience to the user when the user turns or moves, as is common during virtual reality usage. A sensor or other means could be used to determine the orientation of the user to ensure that an effect is provided to the user in a way that corresponds with the virtual environment. For example, when the user looks left, a wind blown from the left-side blower could simulate a frontward wind, as the user is turned left. As such, a more fully immersive virtual reality experience can be achieved. Sensor determination of the user's orientation could be readily determined with the gyroscope or movement system of a virtual reality headset or system to which the tabletop accessory 200 is connected.

Therefore, the tabletop accessory 200 is an accessory that can provide for a more fully immersive virtual reality experience by placing the tabletop accessory 200 on a surface in front of a user or partially surrounding a user, such as on a table. A user can have additional virtual effects, without requiring the user to wear additional materials on a virtual reality headset, which can become otherwise heavy or cumbersome, as well as expensive to make.

To the extent not already described, the different features and structures of the various embodiments of the present disclosure may be used in combination with each other as desired. For example, one or more of the features illustrated and/or described with respect to FIG. 3 can be used with or combined with one or more features illustrated and/or described with respect to the other of the FIGS. 4-7. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A tabletop accessory for providing virtual reality effects to a user, the tabletop accessory comprising:
a body including a set of walls defining an interior; and
a set of effects accessories mounted within the body configured to emit a set of virtual effects to the user;
wherein the tabletop accessory is configured to emit the set of virtual effects to the user positioned in front of the tabletop accessory from the set of effects accessories.

2. The tabletop accessory of claim 1 wherein the set of effects accessories includes at least one speaker, at least one blower, and at least one mist nozzle and the set of virtual effects includes sound, wind, and mist.

3. The tabletop accessory of claim 2 wherein the at least one blower includes a fan and an outlet configured to generate a flow of air from the outlet to provide the wind virtual effect.

4. The tabletop accessory of claim 3 wherein the fan or an inlet for the fan is provided on one wall of the set of walls different than one wall of the set of walls on which the outlet is provided.

5. The tabletop accessory of claim 2 further comprising a reservoir fluidly coupled to the at least one mist nozzle and a pump for providing a volume of liquid to the at least one mist nozzle from the reservoir.

6. The tabletop accessory of claim 1 wherein the set of virtual effects emitted by the set of effects accessories includes three or more of wind, mist, heat, cold, smell, or particulate matter.

7. The tabletop accessory of claim 1 further comprising a controller including a processor and memory operably coupled to the set of effects accessories.

8. The tabletop accessory of claim 7 further comprising an input for communicatively coupling the controller to an entertainment system.

9. The tabletop accessory of claim 8 wherein communication from the entertainment system is parsed by the controller to operate the set of effects accessories in concert with a virtual reality experience from the entertainment system.

10. The tabletop accessory of claim 1 further comprising a set feet on a bottom of the body.

11. The tabletop accessory of claim 1 wherein the tabletop accessory is shaped to at least partially surround the user.

12. The tabletop accessory of claim 11 wherein the body is curved to at least partially surround the user.

13. An accessory for providing virtual reality effects to a user, the accessory comprising:
a body including a set of walls defining an interior;
a set of effects accessories mounted within the body configured to emit a set of virtual effects to the user; and
at least one nozzle configured to emit at least one virtual effect of the set of virtual effects to the user;
wherein the accessory is configured to emit the set of virtual effects to the user positioned in front of the accessory from the set of effects accessories.

14. The accessory of claim 13 wherein the set of effects accessories includes at least one speaker, at least one blower, and at least one mist nozzle and the set of virtual effects includes sound, wind, and mist.

15. The accessory of claim 14 wherein the at least one blower includes a fan and an outlet configured to generate a flow of air from the outlet to provide the wind virtual effect.

16. The accessory of claim 15 wherein the fan or an inlet for the fan is provided on one wall of the set of walls different than one wall of the set of walls on which the outlet is provided.

17. The accessory of claim 14 further comprising a reservoir fluidly coupled to the at least one mist nozzle and a pump for providing a volume of liquid to the at least one mist nozzle from the reservoir.

18. The accessory of claim 1 wherein the set of virtual effects emitted by the set of effects accessories includes three or more of wind, mist, heat, cold, smell, or particulate matter.

19. An accessory for providing virtual reality effects to a user, the accessory comprising:
a body including a set of walls defining an interior;
a speaker mounted within the body configured to emit sound toward a user;
a blower mounted within the body configured to emit a flow of air toward the user;
a reservoir provided within the interior carrying a volume of liquid; and
at least one nozzle configured to emit a mist effect toward the user by emitting at least some of the liquid from the reservoir.

20. The accessory of claim 19 further comprising a pump for providing the volume of liquid to the at least one nozzle from the reservoir.
